(19) United States
(12) Patent Application Publication
(10) Pub. No.: US 2004/0172364 A1
(43) Pub. Date: Sep. 2, 2004

(54) Commercial travel passenger identification security system and process

(76) Inventors: Thomas W. Murray, Fairfax, VA (US); Lyn M. Gubser, Alexandria, VA (US)

Correspondence Address: Lyn M. Gubser, 603 Beverley Drive, Alexandria, VA, 22305, US

(21) Appl. No.: 10/371,072

(22) Filed: Feb. 24, 2003

(51) Int. Cl. G06F 17/60

(52) U.S. Cl. 705/50

(57) ABSTRACT

Systems and methods are provided wherein commercial travel passengers are identified and credentialed to optimize commercial carrier security, including air, rail, motor coach, ship, and other. The systems and methods optimize the security of the carrier; passengers and baggage by issuing each passenger with a unique biometrically enabled credential that authenticates their identity and security level and associates, said passenger with their respective baggage, thereby minimizing the risk of their carriage. Components include a proprietary risk analysis engine used for matriculation and credentialing decisions; biometrically enabled credential devices for passenger identification, certification, and verification, and the employment of transponder-enabled identification devices for matching passengers with their baggage. The process and system result in a passenger security model that undeniably verifies the identity of the respective passenger and the ownership of the baggage of the respective passenger.

### CROSS REFERENCE TO RELATED APPLICATIONS

US Patents Documents

| U.S. Pat. No. | Date | Inventors | US Class. |
|---|---|---|---|
| 4,711,994 | December, 1987 | Greenburg | 235/384 |
| 5,421,619 | June, 1995 | Dyball | 283/86 |
| 5,505,494 | April, 1996 | Belluci, et al. | 283/75 |
| 5,912,981 | June, 1999 | Hansmire, et al. | 382/116 |
| 5,920,053 | July, 1999 | DeBrouse | 235/375 |
| 5,991,429 | November, 1999 | Coffin, et al. | 382/118 |
| 6,006,328 | December, 1999 | Drake | 713/200 |
| 6,101,477 | August, 2000 | Hohle, et al. | 705/1 |
| 6,119,096 | September, 2000 | Mann, et al. | 705/5 |
| 6,137,895 | October, 2000 | Al-Sheikh, et al. | 382/115 |
| 6,158,658 | December, 2000 | Barclay | 235/384 |
| 6,229,445 | May, 2001 | Wack | 340/572.7 |
| 6,246,320 | June, 2001 | Monroe | 340/506 |
| 6,335,688 | January, 2001 | Sweatte | 340/573.1 |
| 6,356,228 | March, 2002 | Tomita | 342/33 |

### STATEMENT REGARDING FED-SPONSORED R&D

The R&D that produced this invention was privately financed and did not receive any federal or other governmental financial support of any kind.

### REFERENCE TO SEQUENCE LISTING, A TABLE OR A COMPUTER PROGRAM LISTING COMPACT DISK APPENDIX

Not Applicable.

### BACKGROUND OF THE INVENTION

Following the Jul. 17, 1996, explosion of TWA Flight 800 near Long Island, N.Y., which claimed the lives of 230 people, rumors began to circulate that this was a terrorist action. Although officials later concluded that it was not, Flight 800 served as a catalyst that raised the concerns of many frequent business flyers and their employers that security on commercial air carriers was far less than adequate.

Soon after the 1996 tragedy, Thomas Murray and Lyn Gubser, technologists and researchers by trade, began to conceptualize and test models of air carrier security and safety. At the time, however, component technologies for the system they created were costly and technically inadequate. These factors, added to the complacency to which the traveling public soon returned; negated acceptance of their prototype by the air security industry.

Capabilities of component technologies, however, have since increased as cost has decreased. By spring of 2001, improvements in biometric and coding equipment and software had developed to the point that the system invented by Murray and Gubser could function with marked accuracy and at marketable cost. A new company—TechTravelers, Inc.—was formed around their invention in July of 2001. The September 11^{th} attacks underscored the importance to the American public of the system that Murray and Gubser have devised.

### BRIEF SUMMARY OF THE INVENTION

A systematic process of registration, certification, authentication, and verification of passenger identity for commercial air, rail, and coach carriers, as well as passenger ships. Components include a proprietary risk analysis engine used for passenger authentication (background checks); biometric devices for passenger certification and verification and for issuing biometrically enabled digital credentials; and coding mechanisms for linking passengers with both their carry-on and checked baggage.

### BRIEF DESCRIPTION OF THE DRAWING

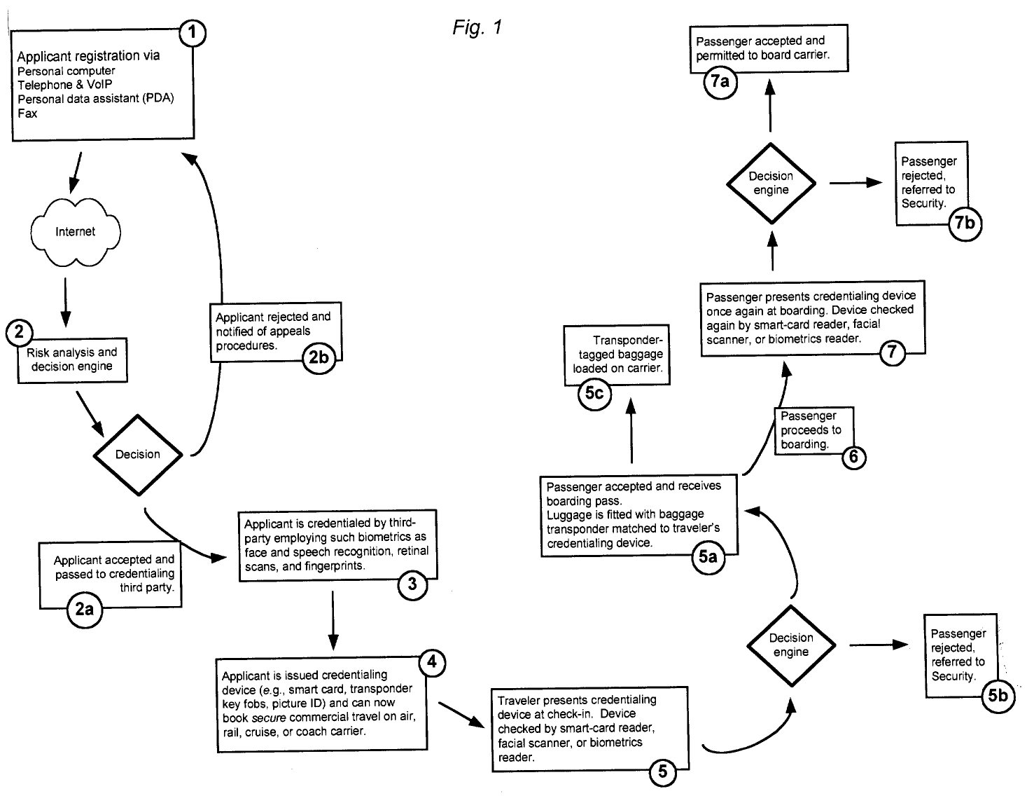

The attached diagram (FIG. 1) illustrates the system's web- and telephonically enabled registration portal and the interaction with the various technology components of the total system. FIG. 1 is numerically labeled indicating each step in the respective process. These include:

\mathring{1} Applicant registration (applicant registers through computer, telephone or VoIP, personal data assistant (PDA), or fax.

\mathring{2} Risk analysis and decision engine (applicant background check)

2a—applicant accepted and passed to credentialing third party.

2b—applicant rejected and notified of appeals procedures.

\mathring{3} Applicant credentialed by third party employing such biometrics as face and speech recognition, retinal scans, and fingerprints.

\mathring{4} Applicant issued credentialing device (e.g., smart card, transponder key fobs, picture ID) and can now book secure commercial travel on air, rail, cruise, or coach carrier.

\mathring{5} Traveler presents credentials at check-in. Device checked by smart-card reader, facial scanner, or biometrics reader.

5a—Passenger accepted and receives boarding pass. Luggage is fitted with baggage transponder matched to traveler's credentialing device.

5b—Passenger rejected. Referred to Security.

\mathring{6} Passenger proceeds to boarding

\mathring{7} Passenger presents credentialing device once again at boarding. Device checked again by smart-card reader, facial scanner, and/or biometrics reader.

7a—Passenger accepted and permitted to board carrier.

7b—Passenger rejected. Referred to security.

### DETAILED DESCRIPTION

### Commercial Travel Passenger Identification Security System and Process

a. Applicant registers via web portal, phone, mail, or fax, submitting detailed identification information and personal history, including social security number, age, sex, occupational information, information regarding any arrests or convictions, and personal references.

b. Application data is processed by a proprietary risk analysis and decision engine. The data is reconciled against and compared to national, state, and local police and judicial system databases and credit bureau records. A pass/fail decision is made, similar to an automated underwriting process, whether to accept or reject the applicant.

c. If the decision is to reject, the applicant is notified in writing of the reason(s) for rejection. Appeal procedures are listed and explained.

d. If the application is accepted, the traveler's data are transferred to a third party to issue a digital credential. The system is credential agnostic, which means that it can accommodate all known preferences of the employing party, including fingerprint- or biometric-enabled smart cards, tokens, transponder key fobs, and other personal identification devices.

e. Applicant receives credential and activation instructions and activates his or her credentials as one would activate a credit card. Once completed, the traveler is matriculated into the system, and is free to book travel in any system that recognizes the Commercial Travel Passenger Identification Security System and Process.

f. At time of travel, the traveler presents credentials upon check-in. Biometric and other personal identification devices match the passenger to data encoded on the passenger's personal identification device (e.g., smart card) and to the code assigned at time of purchase of ticket. Both the passenger's carry-on and checked luggage is coded with this same data so that luggage is numerically matched to its respective owner.

g. Upon boarding, Step f is repeated, and the passenger's credentials are once again read by personal identification devices and compared to metrics previously stored in the carrier's system.

The Commercial Travel Passenger Identification Security System and Process satisfies the three basic needs of personal identification, verification, and authentication. Succinctly stated, these three needs include (1) something you know, (2) something you have, and (3) something you are. These principles of security are satisfied when all three criteria are matched. Within the present system, “something you know” includes a confidential account number and password; “something you have” is provided by a credential in the possession of the traveler (e.g., a smart card or transponder fob); “something you are” is demonstrated by biometric authentication, such as a facial scan, fingerprint(s), or retinal image. By having a third party issue the credential, this system delivers a high level of security especially difficult to breach.

While this invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

Furthermore, it should be noted that those of the appended claims that do not include language in the “means for performing a specified function” format permitted under 35 USC Section 112 (paragraph.6), are not intended to be interpreted under 35 USC Section 112 (paragraph 6) as being limited to the structure, material, or acts described in the present specification and their equivalents.

### Parent Case Text

This application is related to U.S. Provisional patent application 60/350/437 and claims priority from that provisional application and hereby incorporates that provisional application by reference.

What is claimed is:

1. A commercial travel passenger identification security system and process whereby commercial passenger carriers, including air, rail, motor coach, ship, and other, can optimize the security of their passengers and equipment by requiring passengers to present an electronic credential that authenticates their identity and minimizes the risk of their carriage. Prospective passengers must (a) submit an application for secure travel credentialing that includes personal information and references. The application is (b) reviewed and the applicant's references, credit history, and police and judicial records are evaluated against specific criteria that rate the level of risk in credentialing them as passengers. (c) Rejected applicants are notified of the specific reasons for their rejection and an appeals process is made available to them. (d) Accepted applications are referred to a third-party that serves as a credentialing agent. The credentialing agent must employ one or more biometric devices, such as facial scans, speech recognition, retinal scans, or fingerprinting, to authenticate the identification of the applicant, conjointly wedding these biometrics to the applicant's birth record, passport, driver's license, employee identification, security clearances, or any of a number of other identifying credentials presented by the applicant in support of his or her application. (e) The successful applicant is issued an identifying code as well as a credentialing device, such as a PCMCIA (smart) card, transponder key fob, picture identification, or any combination thereof. (f) Upon booking travel, the credentialed traveler presents his or her identifying code that corresponds with his or her credentialing device. Coded tickets are issued to the traveler. (g) At check-in, the traveler presents his or her credentialing device, which is read by equipment assigned to the carrier and matched to the facial scan, speech recognition, retinal scan, or fingerprints of the traveler provided at time of check-in. (h) At check-in, all baggage is searched, sealed, and equipped with a transponder chip or other device that matches the passenger's credentialing device and transponder code. (i) At time of boarding, traveler uses credentialing device as an access key to gain admission to the conveyance. (j) At time of arrival, passenger uses credentialing device to retrieve checked baggage.

2. The method of claim 1, whereby a prospective passenger, or applicant, is required to seek credentialing for access to optimally secure travel.

3. The method of claim 1, wherein the applicant's references, credit history, and police and judicial records undergo risk analysis to determine the suitability of the applicant for clearance to be credentialed for optimally secure travel.

4. The device of claim 3, constituting a risk analysis engine employed in evaluating the passenger's suitability for secure travel credentialing.

5. The method of claim 1, whereby applicants denied credentialing are provided an appeals procedure.

6. The method of claim 1, whereby applicants are referred to a third party for credentialing.

7. The medium of claim 1, whereby the third party establishes the unique identity of the prospective passenger.

8. The apparatus of claim 1, with which the third party equips the prospective passenger to serve as an unique identifier.

9. The method of claim 1, whereby the prospective passenger is issued an identifying code that corresponds to his or her unique identifier.

10. The method of claim 1, whereby the credentialed passenger employs his or her unique identifying code in purchasing travel tickets.

11. The method of claim 1, whereby the identity of the credentialed passenger is authenticated by the carrier at time of check-in.

12. The medium of claim 1, whereby the carrier identifies the credentialed passenger and issues him or her a boarding pass a boarding pass at time of check-in.

13. The apparatus of claim 1 employed by the carrier to ascertain and authenticate the identity of the credentialed passenger and to issue a unique transponder code wed to the passenger's boarding pass and unique identifying credential.

14. The medium of claim 1, whereby the carrier marks the passenger's baggage with the unique transponder code matching the unique code issued on the passenger's boarding pass.

15. The method of claim 14 employed by the carrier to mark the passenger's baggage with the unique transponder code matching the unique code issued on the passenger's boarding pass.

16. The method of claim 1 employed by the carrier to verify the identity of the credentialed passenger at time of boarding the travel conveyance.

17. The apparatus of claim 16 employed by the carrier to verify the identity of the credentialed passenger at time of boarding the travel conveyance.
